(19) United States
(12) Patent Application Publication
(10) Pub. No.: US 2018/0129206 A1
(43) Pub. Date: May 10, 2018

(54) VEHICLE CONTROL DEVICE

(71) Applicant: HONDA MOTOR CO., LTD, Tokyo (JP)

(72) Inventors: Riho Harada, Wako-shi (JP); Shigehiro Honda, Wako-shi (JP); Jun Tanaka, Wako-shi (JP); Takuyuki Mukai, Wako-shi (JP); Jun Ibuka, Wako-shi (JP)

(21) Appl. No.: 15/800,193

(22) Filed: Nov. 1, 2017

(30) Foreign Application Priority Data
Nov. 7, 2016 (JP) 2016-217293

(51) Int. Cl. G05D 1/00; G05D 1/02; B62D 15/02; B60Q 1/34

(52) U.S. Cl. CPC G05D 1/0088; G05D 1/0223; G05D 2201/0213; G05D 1/0061; B60Q 1/346; B62D 15/0255

(57) ABSTRACT

A vehicle control device is equipped with a merging point detection unit adapted to detect a merging point during a congested state on a planned travel route of a host vehicle, an entry space searching unit adapted to search for an entry space for the host vehicle within a merging destination lane, a countermeasure control unit adapted to perform a countermeasure control to contend with merging into the merging destination lane while continuing to automatically drive the host vehicle, in the event that a search result is obtained which indicates that an entry space does not exist.

### CROSS-REFERENCE TO RELATED APPLICATION

This application is based upon and claims the benefit of priority from Japanese Patent Application No. 2016-217293 filed on Nov. 7, 2016, the contents of which are incorporated herein by reference.

### BACKGROUND OF THE INVENTION

### Field of the Invention

The present invention relates to a vehicle control device which at least partially carries out a travel control for a host vehicle by way of automated driving.

### Description of the Related Art

Conventionally, a vehicle control device has been known in which a travel control for a user's own vehicle (also referred to herein as a “host vehicle”) is performed at least partially by way of automated driving. For example, various timing control techniques have been developed for smoothly transitioning between operation modes.

International Publication No. WO2016/035485 proposes a method and system for switching over to manual driving from automated driving prior to arrival at a branching point, in the event that a branching point satisfying a predetermined condition exists in front in a travel direction of a host vehicle which is being driven automatically. The prescribed condition is assumed to be a condition that relates primarily to the shape of the road, for example, a condition in which, in the case that traveling of the host vehicle is taking place, it is necessary to change the orientation of the host vehicle beyond a predetermined angle.

### SUMMARY OF THE INVENTION

Incidentally, in the case that the host vehicle travels through a merging point of different roads, an operation to merge into a merging destination lane in which the traffic volume is relatively large is considered to have a higher degree of difficulty in comparison with a case in which the traffic volume is relatively small. However, if there is an occurrence of traffic congestion in the merging destination lane, the host vehicle may search for an entry space within the merging destination lane while traveling at a low speed in a pre-merging lane (i.e., in the case of an expressway, an acceleration lane or an entrance ramp), whereupon it is tentatively possible for a merging operation to be performed while automated driving is continued.

However, when the method proposed in International Publication No. WO2016/035485 is applied without modification to a merging point (roads satisfying a predetermined condition) during the occurrence of traffic congestion, regardless of local or temporal changes in the congestion situation, switching over to manual driving is carried out without even attempting to continue with automated driving. As a result, since the segment in which automated driving is executed becomes shortened, merchantability of the vehicle tends to be impaired from the standpoint of driving convenience.

The present invention has been devised in order to solve the aforementioned problems, and has the object of providing a vehicle control device which is capable of improving driving convenience in the case of traveling through a merging point during a period of traffic congestion.

A vehicle control device according to the present invention is a device adapted to at least partially carry out a travel control for a host vehicle by way of automated driving, comprising a merging point detection unit adapted to detect a merging point during a congested state on a planned travel route of a host vehicle, an entry space searching unit adapted to search for an entry space for the host vehicle within a merging destination lane that passes through the merging point, while the host vehicle is traveling by way of automated driving in a pre-merging lane that leads to the merging point detected by the merging point detection unit, and a countermeasure control unit adapted to perform a merging control that causes the host vehicle to enter into the entry space in the event that a search result is obtained from the entry space searching unit which indicates that the entry space exists, or on the other hand, to perform a countermeasure control to contend with merging into the merging destination lane while continuing to automatically drive the host vehicle, in the event that a search result is obtained which indicates that an entry space does not exist.

In this manner, in the case that a search result is obtained which indicates that an entry space for the host vehicle does not exist, a countermeasure control is performed to contend with merging into the merging destination lane while automated driving of the host vehicle is continued. Therefore, it is possible to continue with automated driving without interruption until a search result is obtained which indicates that an entry space exists, and thus, driving convenience is improved in the case of traveling through a merging point during a state of traffic congestion.

Further, in the case that a search result is obtained which indicates that the entry space does not exist, the countermeasure control unit may perform the countermeasure control to cause the host vehicle to stop in the pre-merging lane on the near side of the merging point. In accordance with this feature, it is possible to cause the host vehicle to wait in the pre-merging lane until an entry space is discovered.

Further, the countermeasure control unit may perform the countermeasure control to cause the host vehicle to stop in a direction that facilitates merging of the host vehicle. More specifically, the countermeasure control unit may perform the countermeasure control to cause the host vehicle to stop in a state in which a vehicle body or a steering angle thereof is inclined in an orientation converging with the merging destination lane. In accordance with this feature, after the entry space is discovered, it is possible to smoothly and promptly cause the host vehicle to merge into the merging destination lane.

Further, in the case that another vehicle in the pre-merging lane approaches from behind the host vehicle, the countermeasure control unit may perform the countermeasure control to incline the steering angle in a direction away from the merging destination lane in a stopped state of the host vehicle. In accordance with this feature, even in the case that the host vehicle is pushed forward as a result of a collision from behind by the other following vehicle, the host vehicle will move in a direction away from the merging destination lane, or alternatively, a sufficient distance margin can be provided until entering into the merging destination lane.

The vehicle control device may further comprise a takeover request unit adapted to perform an operation to request that a driver take over manual operation of the host vehicle, in the event that a search result is obtained which indicates that the entry space does not exist after a predetermined time period has elapsed from a point in time when the host vehicle was stopped. In accordance with this feature, in a traffic situation in which time is required until completion of merging, it is possible for the driver to smoothly take over the responsibility for driving.

Further, in the case that a search result is obtained which indicates that the entry space does not exist, the countermeasure control unit may perform the countermeasure control to operate a direction indicator on the side of the merging destination lane. In accordance with this feature, it is possible to provide a visual indication with respect to other vehicles in the merging destination lane of the intention of the host vehicle to perform merging.

In accordance with the vehicle control device of the present invention, it is possible to improve driving convenience in the case of traveling through a merging point during a period of traffic congestion.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a block diagram showing the configuration of a vehicle control device according to an embodiment of the present invention;

FIG. 2 is a flowchart for describing operations of the vehicle control device shown in FIG. 1;

FIG. 3 is a diagram showing a situation of traffic congestion at a merging point of an expressway;

FIGS. 4A and 4B are diagrams showing the behavior of a host vehicle in accordance with a first countermeasure;

FIGS. 5A and 5B are diagrams showing the behavior of the host vehicle in accordance with a merging control;

FIG. 6A is a diagram showing the behavior of the host vehicle in accordance with a second countermeasure;

FIG. 6B is a diagram showing the behavior of the host vehicle in accordance with a third countermeasure;

FIGS. 7A and 7B are diagrams showing an effect of the third countermeasure;

FIGS. 8A and 8B are diagrams showing the behavior of the host vehicle in accordance with a fourth countermeasure; and

FIGS. 9A and 9B are diagrams showing the behavior of the host vehicle in accordance with a fifth countermeasure.

### DESCRIPTION OF THE PREFERRED EMBODIMENTS

Preferred embodiments of a vehicle control device according to the present invention will be presented and described in detail below with reference to the accompanying drawings.

### [Configuration of Vehicle Control Device 10]

### <Overall Configuration>

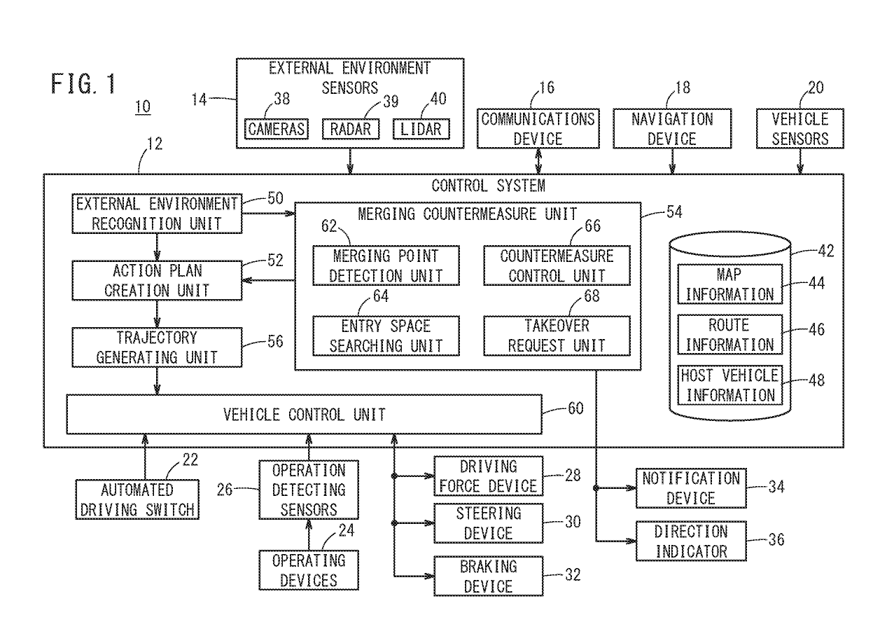

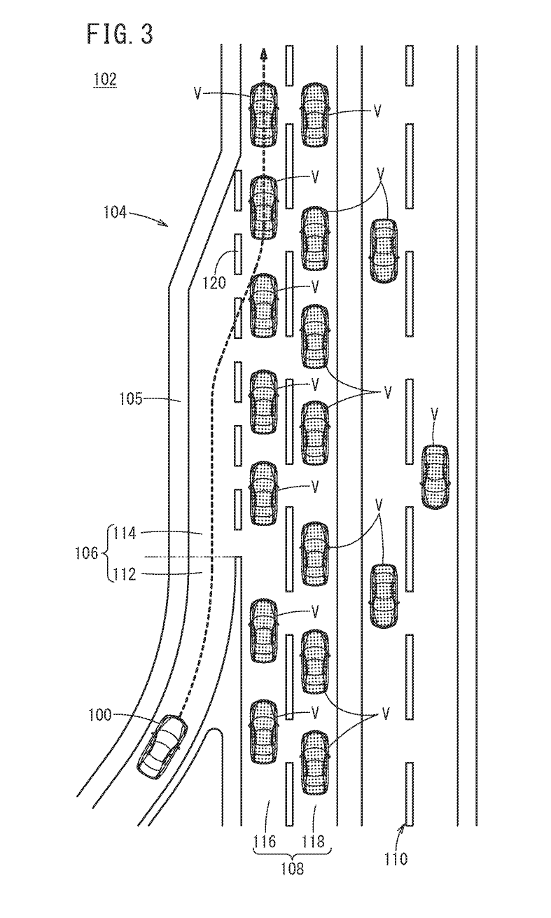

FIG. 1 is a block diagram showing the configuration of a vehicle control device 10 according to an embodiment of the present invention. The vehicle control device 10 is incorporated in a vehicle (the host vehicle 100 shown in FIG. 3, etc.), and performs a travel control for the vehicle by way of automated driving or manual driving. The term “automated driving” as used herein implies a concept that includes not only “fully automated driving” in which the travel control for the vehicle is performed entirely automatically, but also “partial automated driving” or “driving assistance” in which the travel control is partially performed automatically.

The vehicle control device 10 is basically made up from an input system device group, a control system 12, and an output system device group. The respective devices of the input system device group and the output system device group are connected via communication lines to the control system 12.

The input system device group includes external environment sensors 14, a communications device 16, a navigation device 18, vehicle sensors 20, an automated driving switch 22, and operation detecting sensors 26 connected to operating devices 24.

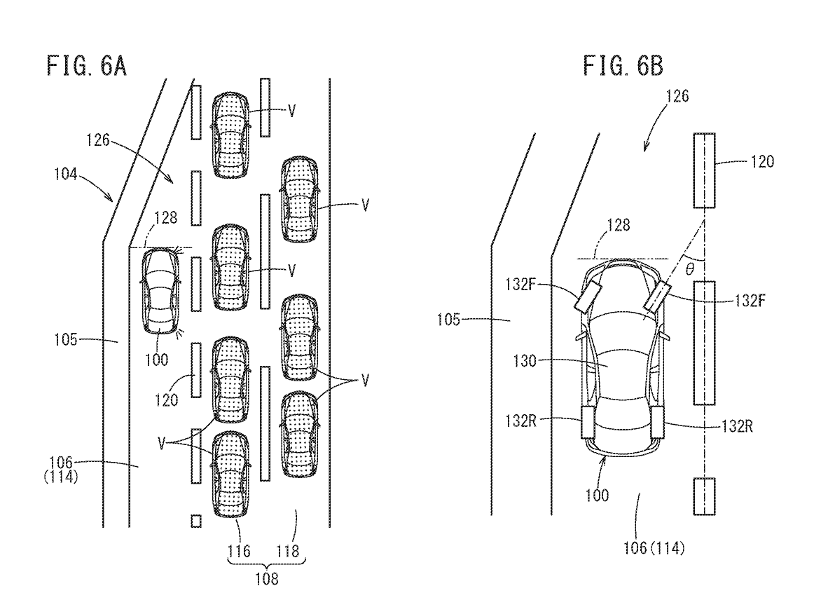

The output system device group includes a driving force device 28 for driving the vehicle wheels 132F, 132R (see FIG. 6B, etc.), a steering device 30 for steering the vehicle wheels 132F(R), a braking device 32 for braking the vehicle wheels 132F(R), a notification device 34 for notifying the driver primarily through visual and auditory sensation, and a direction indicator 36 to indicate a direction in which the vehicle is heading.

### <Specific Configuration of Input Device Group>

The external environment sensors 14 acquire information (hereinafter referred to as external environmental information) indicative of the state of the external environment around the vehicle, and output the acquired external environmental information to the control system 12. More specifically, the external environment sensors 14 are configured to include a plurality of cameras 38, a plurality of radar devices 39, and a plurality of LIDAR devices 40 (Light Detection and Ranging; Laser Imaging Detection and Ranging).

The communications device 16 is configured to be capable of communicating with external devices including roadside devices, other vehicles, and a server, and transmits and receives, for example, information related to transportation facilities, information related to other vehicles, probe information, or latest map information 44. The map information 44 is stored in a predetermined memory area of the storage device 42, or alternatively in the navigation device 18.

The navigation device 18 is constituted to include a satellite positioning device, which is capable of detecting a current position of the vehicle, and a user interface (for example, a touch-panel display, a speaker, and a microphone). Based on the current position of the vehicle or a position designated by the user, the navigation device 18 calculates a route to a designated destination point, and outputs the route to the control system 12. The route calculated by the navigation device 18 is stored as route information 46 in a predetermined memory area of the storage device 42.

The vehicle sensors 20 output to the control system 12 detection signals from respective sensors, including a speed sensor for detecting the travel speed (vehicle velocity), an acceleration sensor for detecting an acceleration, a lateral G sensor for detecting a lateral G force, a yaw rate sensor for detecting an angular velocity about a vertical axis, an orientation sensor for detecting an orientation, and a gradient sensor for detecting a gradient of the vehicle. The detection signals are stored as host vehicle information 48 in a predetermined memory area of the storage device 42.

The automated driving switch 22, for example, is a pushbutton switch provided on the instrument panel. The automated driving switch 22 is configured to be capable of switching between a plurality of driving modes exhibiting differing degrees of automated driving, by manual operation thereof by a user including the driver.

The operating devices 24 include an accelerator pedal, a steering wheel, a brake pedal, a shift lever, and a direction indication (turn signal) lever. The operation detecting sensors 26, which detect the presence or absence or the operated amounts of operations made by the driver, as well as operated positions, are attached to the operating devices 24.

The operation detecting sensors 26 output to the vehicle control unit 60 as detection results an amount by which the accelerator pedal is depressed (degree of accelerator opening), an amount (steering amount) by which the steering wheel is operated, an amount by which the brake pedal is depressed, a shift position, and a right or left turn direction, etc.

### <Specific Configuration of Output System Device Group>

The driving force device 28 is constituted from a driving force ECU (Electronic Control Unit), and a drive source including an engine and/or a driving motor. The driving force device 28 generates a travel driving force (torque) for the vehicle to travel in accordance with vehicle control values input thereto from the vehicle control unit 60, and transmits the travel driving force to the vehicle wheels 132F(R) directly or through a transmission.

The steering device 30 is constituted from an EPS (electric power steering system) ECU, and an EPS device. The steering device 30 changes the orientation of the vehicle wheels 132 F(R) in accordance with vehicle control values input thereto from the vehicle control unit 60.

The braking device 32, for example, is an electric servo brake used in combination with a hydraulic brake, and is made up from a brake ECU and a brake actuator. The braking device 32 brakes the vehicle wheels 132F(R) in accordance with vehicle control values input thereto from the vehicle control unit 60.

The notification device 34 is made up from a notification ECU, a display device, and an audio device. In accordance with a notification command output from the control system 12 (more specifically, a merging countermeasure unit 54 thereof), the notification device 34 carries out a notification operation in relation to automated driving or manual driving (including a takeover request TOR, to be described later). The direction indicator 36 is disposed in front of, behind, or on the sides of the vehicle, and is made up of lamps which indicate to the surrounding vicinity a turning direction when turning or veering to the right or left or when changing course.

### <Driving Modes>

An “automated driving mode” and a “manual driving mode” (non-automatic driving mode) are switched sequentially each time that the automated driving switch 22 is pressed. Instead of this feature, in order to provide confirmation of a driver's intention, it is possible to provide settings in which, for example, switching from the manual driving mode to the automated driving mode is effected by pressing twice, and switching from the automated driving mode to the manual driving mode is effected by pressing once.

The automated driving mode is a driving mode in which the vehicle travels under the control of the control system 12 while the driver does not operate the operating devices 24 (specifically, the accelerator pedal, the steering wheel, and the brake pedal). Stated otherwise, in the automated driving mode, the control system 12 controls a portion or all of the driving force device 28, the steering device 30, and the braking device 32 in accordance with sequentially created action plans.

When the driver performs a predetermined operation using the operating devices 24 during implementation of the automated driving mode, the automated driving mode is canceled automatically, together with switching to a driving mode (which may include the manual driving mode) in which the degree of automated driving is relatively low. Hereinafter, an operation in which the driver operates the automated driving switch 22 or any one of the operating devices 24 in order to transition from automated driving to manual driving will also be referred to as a “takeover operation”.

### <Configuration of Control System 12>

The control system 12 is constituted by one or a plurality of ECUs, and comprises various function realizing units in addition to the aforementioned storage device 42. According to the present embodiment, the function realizing units are software-based functional units, in which the functions thereof are realized by one or a plurality of CPUs (central processing units) executing programs that are stored in the non-transitory storage device 42. Alternatively, the function realizing units may be hardware-based functional units made up from integrated circuits such as field-programmable gate arrays (FPGA) or the like.

In addition to the storage device 42 and the vehicle control unit 60, the control system 12 is configured to include an external environment recognition unit 50, an action plan creation unit 52, a merging countermeasure unit 54, and a trajectory generating unit 56.

Using various information input thereto from the input system device group (for example, external environment information from the external environment sensors 14), the external environment recognition unit 50 recognizes lane markings (white lines) on both sides of the vehicle, and generates “static” external environment recognition information, including location information of stop lines and traffic signals, or travel enabled regions in which traveling is possible. Further, using the various information input thereto, the external environment recognition unit 50 generates “dynamic” external environment recognition information, including information concerning obstacles such as parked or stopped vehicles, traffic participants such as people and other vehicles, and the colors of traffic signals.

On the basis of recognition results from the external environment recognition unit 50, the action plan creation unit 52 creates action plans (a time series of events) for each of respective travel segments, and updates the action plans as needed. As types of events, for example, there may be cited events in relation to deceleration, acceleration, branching, merging, lane keeping, lane changing, and passing other vehicles. In this instance, “deceleration” and “acceleration” are events in which the vehicle is made to decelerate or accelerate. “Branching” and “merging” are events in which the vehicle is made to travel smoothly at a branching point or a merging point. “Lane changing” is an event in which the travel lane of the vehicle is made to change. “Passing” is an event in which the vehicle is made to overtake a preceding vehicle.

Further, “lane keeping” is an event in which the vehicle is made to travel without departing from the travel lane, and is subdivided into a combination of travel modes. More specifically, as such travel modes, there may be included constant speed traveling, follow-on traveling, traveling while decelerating, traveling through a curve, or traveling to avoid obstacles.

The merging countermeasure unit 54 carries out processes in relation to the merging operation of the vehicle, and outputs signals to the action plan creation unit 52, the notification device 34, or the direction indicator 36. More specifically, the merging countermeasure unit 54 functions as a merging point detection unit 62, an entry space searching unit 64, a countermeasure control unit 66, and a takeover request unit 68.

Using the map information 44, the route information 46, and the host vehicle information 48 which are read from the storage device 42, the trajectory generating unit 56 calculates a travel trajectory (a time series of target behaviors) in accordance with the action plan created by the action plan creation unit 52. More specifically, the travel trajectory is a time series data set, in which the data units thereof are defined by a position, a posture angle, a velocity, an acceleration, a curvature, a yaw rate, and a steering angle.

The vehicle control unit 60 determines respective vehicle control values in order to control traveling of the vehicle, in accordance with the travel trajectory (time series of target behaviors) generated by the trajectory generating unit 56. In addition, the vehicle control unit 60 outputs the obtained vehicle control values, respectively, to the driving force device 28, the steering device 30, and the braking device 32.

### [Operations of Vehicle Control Device 10]

### <Overall Process Flow>

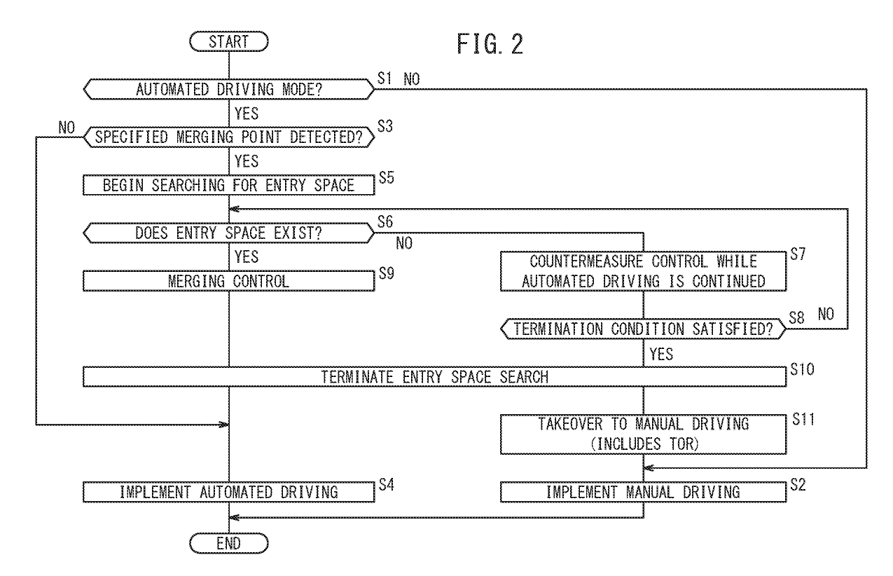

The vehicle control device 10 according to the present embodiment is configured basically in the manner described above. Next, operations of the vehicle control device 10 (in particular, a merging control and a countermeasure control) will be described with reference primarily to the flowchart shown in FIG. 2. In this instance, cases will be assumed in which the host vehicle 100, which is equipped with the vehicle control device 10, travels by way of automated driving or manual driving.

As shown in FIG. 3, the host vehicle 100 travels on an expressway 102 along the planned travel route indicated by the broken line arrow, and the host vehicle 100 attempts to pass through a merging point 104. In sequential order from an outer wall 105, the expressway 102 is constituted from a substantially J-shaped pre-merging lane 106, a straight travel side main line 108 on the side on which the host vehicle 100 is traveling, and another straight opposing side main line 110 on the opposite side.

In sequential order from a front side in the travel direction of the host vehicle 100, the pre-merging lane 106 is composed of a ramp-way 112 and an acceleration lane 114. In sequential order from the left side, the travel side main line 108 is made up from a merging destination lane 116 and an overtaking lane 118. Moreover, the acceleration lane 114 and the merging destination lane 116 are partitioned via a boundary line 120 in the form of a broken line.

In the present drawing, a road is illustrated for a country where it has been decided that automobiles are to travel on the left side of the road. The host vehicle 100 is traveling in the pre-merging lane 106 (and more specifically, on the ramp-way 112). The plurality of other vehicles V are traveling in the travel side main line 108, as well as in the opposing side main line 110. A state of congestion in which the traffic density is relatively high is taking place in the travel side main line 108, whereas in the opposing side main line 110, the traffic density is relatively low and a state of congestion is not taking place.

In step S1 of FIG. 2, the control system 12 (and more specifically, the vehicle control unit 60 thereof) determines whether or not the automated driving mode is “ON”. In the case that the automated driving mode is determined to be not “ON” (i.e., “OFF”) (step S1: NO), the vehicle control device 10 implements manual driving of the host vehicle 100 (step S2). On the other hand, if the automated driving mode is determined to be “ON” (step S1: YES), the process proceeds to step S3.

In step S3, the merging point detection unit 62 detects the presence or absence of a specified merging point 104. Such a “specified” merging point 104 is defined, for example, by [1] a condition on the planned travel route of the host vehicle 100, in which [2] a state of congestion is taking place or is likely to take place in the vicinity of the merging point 104, and in which [3] the merging point exists inside of a predetermined distance range from the current position of the host vehicle 100 (or alternatively, a predetermined time range within which the host vehicle 100 is capable of reaching the merging point).

Prior to carrying out such a detection process, the merging point detection unit 62 reads out the map information 44, the route information 46, and the host vehicle information 48 from the storage device 42, and in addition, acquires via the communications device 16 the most recent road traffic information (for example, congestion information, traffic regulation information) from a VICS facility (Vehicle Information and Communication System; registered trademark).

In the case that a specified merging point 104 is not detected (step S3: NO), the vehicle control device 10 continues to implement automated driving of the host vehicle 100 (step S4). On the other hand, if a specified merging point 104 is detected (step S3: YES), the process proceeds to step S5.

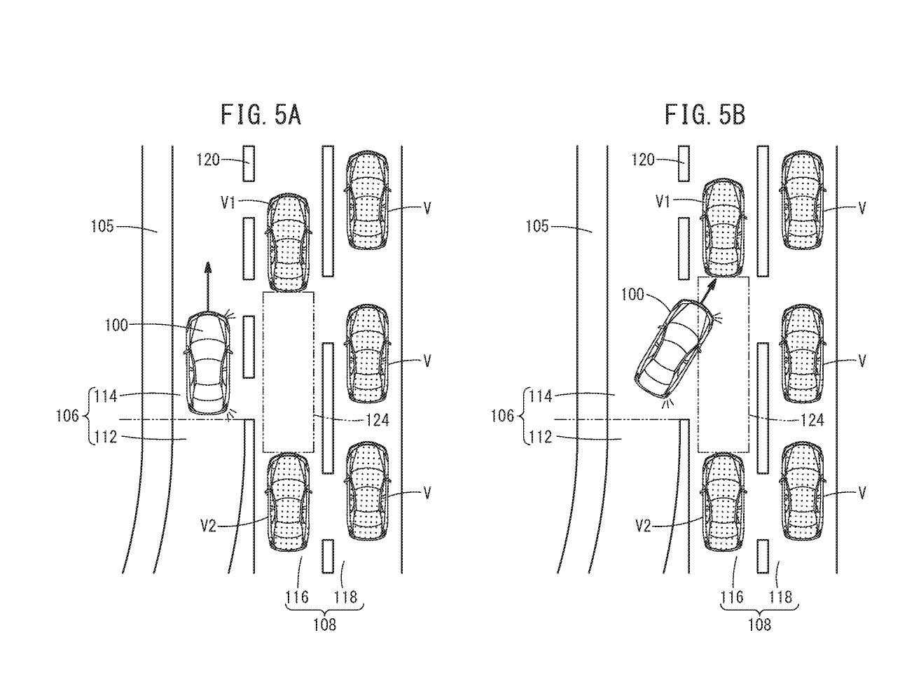

In step S5, the entry space searching unit 64 begins searching for an entry space 124 (see FIG. 5A) in the merging destination lane 116. This process may be executed at a timing (within a time zone) during which the host vehicle 100 is capable of merging into the merging destination lane 116. For example, a point in time at which the host vehicle 100 arrives at the acceleration lane 114 may be set as the start time for the searching process.

In step S6, the entry space searching unit 64 determines whether or not there is at least one entry space 124 for the host vehicle 100. The entry space 124 is located at a position which is accessible to the host vehicle 100, and implies a space that is sufficiently secured to such an extent to allow entry of the host vehicle 100 therein.

More specifically, the entry space searching unit 64 determines an inter-vehicle distance between adjacently disposed other vehicles V in front and rear directions, and may determine the presence or absence of the entry space 124 on the basis of a size relationship thereof with a preset threshold value. The threshold value, for example, is a value obtained by adding (adding or multiplying) a marginal amount with respect to the vehicle length of the host vehicle 100.

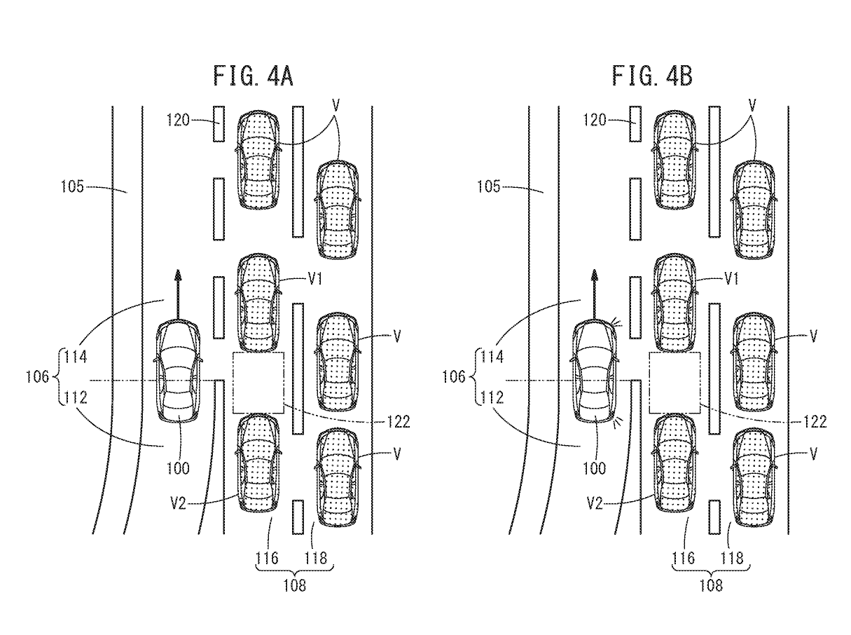

As shown in FIG. 4A, a small space 122 (the region surrounded by the two-dot-dashed line), which is sandwiched between two other vehicles V1 and V2 in proximity to the host vehicle 100, exists in the merging destination lane 116. In the present drawing, in order to distinguish them clearly from the remaining other vehicles V, a preceding vehicle is denoted by V1, whereas a following vehicle is denoted by V2. In this instance, since the small space 122 does not have a sufficient size, a search result is obtained which indicates that an entry space 124 does not exist. When this occurs, since it is determined by the entry space searching unit 64 that an entry space 124 does not exist (step S6 of FIG. 2: NO), the process proceeds to step S7.

In step S7, the countermeasure control unit 66 performs a countermeasure control to contend with merging into the merging destination lane 116 while automated driving is continued without interruption. The “countermeasure control”, for example, is [1] a control to cause the direction indicator 36 to emit light (first countermeasure), [2] a control to stop the host vehicle 100 (second countermeasure), [3] a steering angle directional control (third and fifth countermeasures), [4] a control to orient a vehicle body 130 (fourth countermeasure), or [5] a combination of the aforementioned respective controls.

In this instance, the countermeasure control unit 66 (merging countermeasure unit 54) outputs a signal (hereinafter referred to as a control signal) to the direction indicator 36 in order to carry out a control which causes the direction indicator 36 to emit light. Consequently, the direction indicator 36 emits light in accordance with the control signal from the countermeasure control unit 66.

As shown in FIG. 4B, while traveling along the road in the pre-merging lane 106, the host vehicle 100 causes the direction indicator 36 to emit light (more specifically, to blink or turn on) on the side of the merging destination lane 116. In this manner, in the case that a search result is obtained which indicates that the entry space 124 does not exist, the countermeasure control unit 66 may perform a countermeasure control (first countermeasure) to operate the direction indicator 36 on the side of the merging destination lane 116. In accordance with this feature, it is possible to provide a visual indication with respect to the other vehicles V in the merging destination lane 116 of the intention of the host vehicle 100 to perform merging.

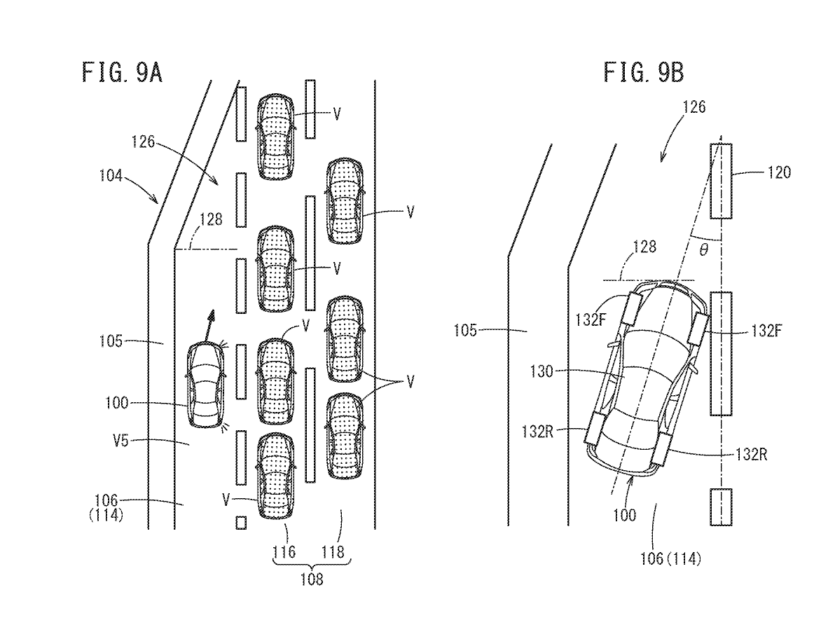

In step S8, the countermeasure control unit 66 determines whether or not a termination condition for the countermeasure control has been satisfied. The termination condition, for example, is [1] a condition in which a predetermined time has elapsed since the start of the searching process, [2] a condition in which the host vehicle 100 has traveled a predetermined distance from a starting point of the searching process, and [3] a condition in which a predetermined time period has elapsed since stoppage of the host vehicle 100 in the state shown in FIG. 6B or 9B. If it is determined that the termination condition has not yet been satisfied (step S8: NO), then steps S6 to S8 are sequentially repeated.

As shown in FIG. 5A, a situation is considered in which another vehicle V2 continues to stop for a short period in order to allow the host vehicle 100 to pass first. On the other hand, by another vehicle V1 advancing in this state, an inter-vehicle distance between the two other vehicles V1 and V2 increases, and therefore a space (i.e., the entry space 124) of sufficient size is formed. In this case, a search result is obtained which indicates that an entry space 124 exists in the merging destination lane 116. When this occurs, since it is determined by the entry space searching unit 64 that an entry space 124 exists (step S6 of FIG. 2: YES), the process proceeds to step S9.

In step S9, the countermeasure control unit 66 performs the merging control to cause the host vehicle 100 to enter into the entry space 124. More specifically, the countermeasure control unit 66 (merging countermeasure unit 54) issues a notification to the action plan creation unit 52 that a lane change is to be performed. Accompanying a change in the action plan, the trajectory generating unit 56 generates a travel trajectory in order to initiate a lane change from the pre-merging lane 106 into the merging destination lane 116. Consequently, the host vehicle 100 travels in accordance with the travel trajectory generated by the trajectory generating unit 56.

As shown in FIG. 5B, accompanying execution of the merging control, the host vehicle 100 enters between the two other vehicles V1 and V2 (into the entry space 124) while the steering wheel is steered to the right. Accordingly, merging into the merging destination lane 116 is completed.

In step S10, the entry space searching unit 64 terminates the process of searching for an entry space 124 in the merging destination lane 116. In addition, the vehicle control device 10 continuously carries out automated driving of the host vehicle 100 (step S4), and performs a travel control for the travel side main line 108 (the merging destination lane 116).

On the other hand, returning to step S8, if a determination is made that the termination condition for the countermeasure control has been satisfied (step S8: YES), the entry space searching unit 64 terminates the process of searching for an entry space 124 in the merging destination lane 116 (step S10).

In step S11, the vehicle control device 10 performs a takeover operation to switch from automated driving to manual driving. More specifically, the takeover request unit 68 performs an operation to request that the driver take over the responsibility for driving, or in other words, to begin driving the host vehicle 100 manually. Upon doing so, responsive to the request operation (notification command) from the takeover request unit 68, the notification device 34 issues a notification to the effect that the driver should take over the responsibility for driving. The series of operations from the request operation to the notification operation is referred to as a “TOR” (takeover request).

In addition, in the case of having accepted a takeover operation by the driver, the vehicle control device 10 switches over to manual driving of the host vehicle 100 (step S2). Thereafter, using the operating devices 24, the driver performs manual driving in order to merge into the merging destination lane 116 from the pre-merging lane 106.

### <Other Examples of Countermeasure Controls>

Incidentally, the countermeasure control unit 66 is not limited to performing the control (first countermeasure) to cause the direction indicator 36 to emit light, but various other types of countermeasure controls may also be performed (step S7). In this instance, it is assumed that the host vehicle 100 travels along a road in the pre-merging lane 106 (in this case, the acceleration lane 114) while continuing to search for an entry space 124.

In this case, the countermeasure control unit 66 (merging countermeasure unit 54) issues a notification to the action plan creation unit 52 to the effect that the later-described second to fifth countermeasures are to be performed. Accompanying a change in the action plan, the trajectory generating unit 56 generates travel trajectories in order to carry out respective countermeasures. Consequently, the host vehicle 100 can be operated and can contend with merging in accordance with the travel trajectory generated by the trajectory generating unit 56.

### (Stopping Control, Case 1)

As shown in FIG. 6A, in the case that the host vehicle 100 was incapable of discovering an entry space 124 even though the host vehicle 100 has arrived in the vicinity of a terminal section 126 of the pre-merging lane 106, the host vehicle 100 is stopped at a position (hereinafter referred to as a stop position 128) on the near (front) side of the terminal section 126. For example, in the case that a stop line exists in proximity to the terminal section 126, the stop position 128 corresponds to the stop line. Alternatively, in the case that such a stop line does not exist, the stop position 128 corresponds to a position separated a predetermined length (more specifically, a length of 5 to 10 meters) from the far end of the outer wall 105.

In this manner, in the case that a search result is obtained which indicates that the entry space 124 does not exist, the countermeasure control unit 66 may perform the countermeasure control (second countermeasure) to cause the host vehicle 100 to stop in the pre-merging lane 106 on a front side (stop position 128) of the merging point 104. In accordance with this feature, it is possible to cause the host vehicle 100 to wait in the pre-merging lane 106 until an entry space 124 is discovered.

### (Steering Control, Case 1)

As shown in FIG. 6B, the host vehicle 100 is in a stopped state in which the orientation of the vehicle body 130 and the orientation of the rear wheels 132R, 132R are substantially in parallel with respect to the direction in which the boundary line 120 extends. On the other hand, the front wheels 132F, 132F are inclined at an angle of inclination θ with respect to the direction in which the boundary line 120 extends. In this instance, since the angle of inclination θ is an acute angle (0 degrees<θ<90 degrees), the front end sides of the vehicle wheels 132F, 132F face toward the merging destination lane 116.

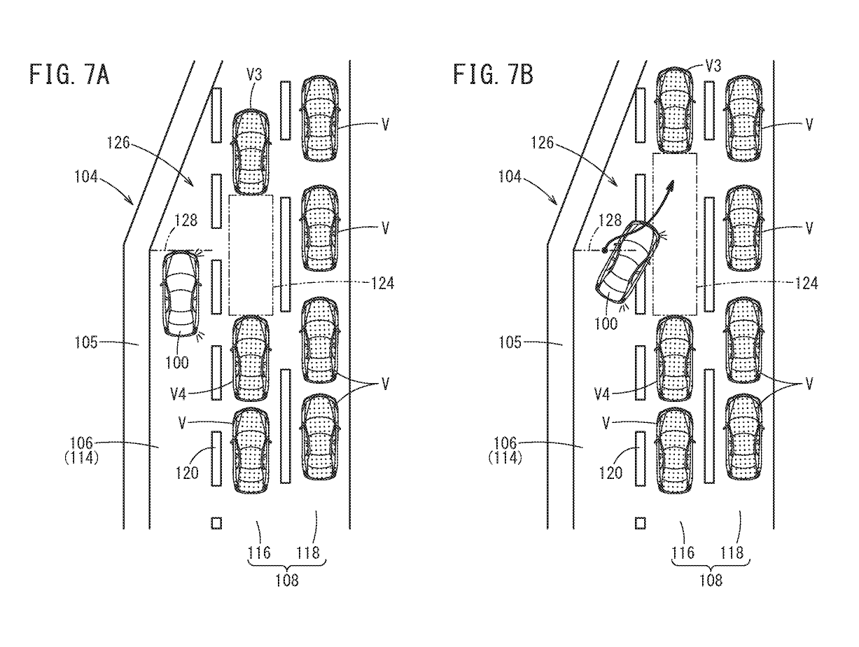

As shown in FIG. 7A, a situation is considered in which another vehicle V4 continues to stop for a short period in order to allow the host vehicle 100 to pass first. On the other hand, by another vehicle V3 which precedes the other vehicle V4 advancing in this state, an inter-vehicle distance between the two other vehicles V3 and V4 increases, and therefore an entry space 124 of sufficient size is formed.

Then, as shown in FIG. 7B, along with implementation of the merging control, the host vehicle 100 begins to travel forward from the stop position 128, and a lane change is performed along the trajectory indicated by the solid arrow. In this instance, since the vehicle wheels 132F, 132F are inclined at the start of traveling, the behavior of the host vehicle 100 at the time of merging becomes smooth.

In this manner, the countermeasure control unit 66 may perform the countermeasure control (third countermeasure) to cause the host vehicle 100 to stop in a direction that facilitates merging of the host vehicle 100, and more specifically, in a state in which the steering angle is inclined in an orientation converging with the merging destination lane 116. In accordance with this feature, after the entry space 124 is discovered, it is possible to smoothly and promptly cause the host vehicle 100 to merge into the merging destination lane 116.

### (Steering Control, Case 2)

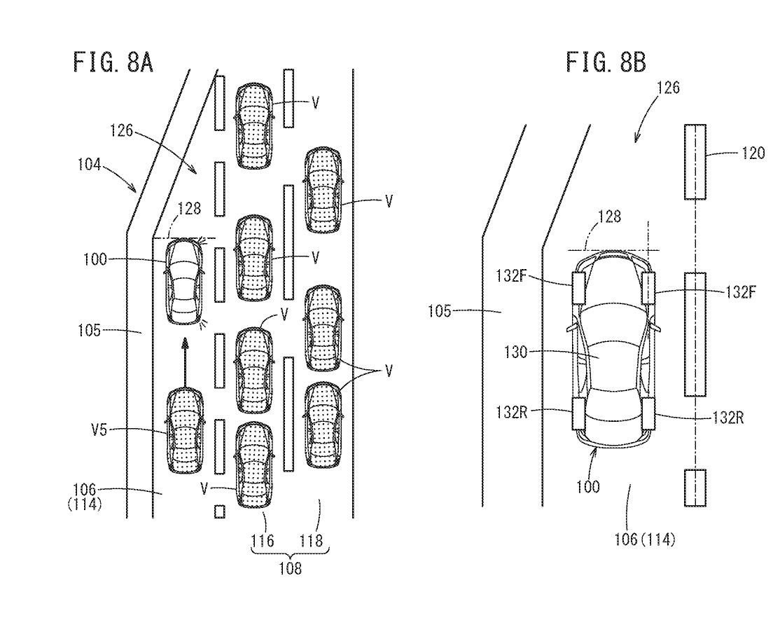

In the case shown in FIG. 8A, another vehicle V5 is traveling in the pre-merging lane 106 following the host vehicle 100. For example, a case may be considered in which the other vehicle V5 approaches from behind the host vehicle 100, and the TTC (Time To Collision) of the other vehicle V5 with respect to the host vehicle 100 becomes smaller than a predetermined threshold value (for example, 1 second). If such a situation occurs, the host vehicle 100 transitions from the stopped state shown in FIG. 6B to the stopped state shown in FIG. 8B.

As shown in FIG. 8B, the host vehicle 100 is in a stopped state in which not only the vehicle body 130 and the rear wheels 132R, 132R thereof, but also the front wheels 132F, 132F are oriented substantially in parallel (angle of inclination θ=0 degrees) with respect to the direction in which the boundary line 120 extends. Stated otherwise, the host vehicle 100 is steered (turned) in a direction away from the merging destination lane 116.

In this manner, in the case that another vehicle V5 in the pre-merging lane 106 approaches from behind the host vehicle 100, the countermeasure control unit 66 may perform the countermeasure control (fourth countermeasure) to incline the steering angle in a direction away from the merging destination lane 116 in a stopped state of the host vehicle 100. In accordance with this feature, even in the case that the host vehicle 100 is pushed forward as a result of a collision from behind by the other following vehicle V5, the host vehicle 100 will move in a direction away from the merging destination lane 116, or alternatively, a sufficient distance margin can be provided until entering into the merging destination lane 116.

### (Stopping Control, Case 2)

As shown in FIG. 9A, in the case that the host vehicle 100 is incapable of discovering an entry space 124 even though the host vehicle 100 has arrived in the vicinity of the terminal section 126, the host vehicle 100 moves from a position on the front side of the stop position 128, and is stopped at the stop position 128 while the steering wheel is steered slightly to the right.

As shown in FIG. 9B, the host vehicle 100 is stopped with the overall orientation thereof being inclined at an angle of inclination θ with respect to the direction in which the boundary line 120 extends. In this instance, since the angle of inclination θ is an acute angle (0 degrees<θ<90 degrees), the front end side of the vehicle body 130 faces toward the merging destination lane 116. Thus, similar to the case of FIG. 7B, when the lane change is carried out, since the vehicle body 130 is inclined at the start of traveling, the behavior of the host vehicle 100 at the time of merging becomes smooth.

In this manner, the countermeasure control unit 66 may perform the countermeasure control (fifth countermeasure) to cause the host vehicle 100 to stop in a direction that facilitates merging of the host vehicle 100, and more specifically, in a state in which the vehicle body 130 is inclined in an orientation converging with the merging destination lane 116. In accordance with this feature, similar to the case of FIG. 6B, after the entry space 124 is discovered, it is possible to smoothly and promptly cause the host vehicle 100 to merge into the merging destination lane 116.

Moreover, the takeover request unit 68 may perform an operation to request that the driver take over manual operation of the host vehicle 100, in the event that a search result is obtained which indicates that the entry space 124 does not exist after a predetermined time period has elapsed from a point in time when the host vehicle 100 was stopped at the stop position 128 (see FIGS. 6B and 9B). In accordance with this feature, in a traffic situation in which time is required until completion of merging, it is possible for the driver to smoothly take over the responsibility for driving.

### [Effects of the Vehicle Control Device 10]

As described above, the vehicle control device 10 is a device which is adapted to at least partially carry out a travel control for the host vehicle 100 by way of automated driving, comprising [1] the merging point detection unit 62 adapted to detect a merging point 104 during a congested state on a planned travel route of the host vehicle 100, [2] the entry space searching unit 64 adapted to search for an entry space 124 for the host vehicle 100 within a merging destination lane 116 that passes through the merging point 104, while the host vehicle 100 is traveling by way of automated driving in a pre-merging lane 106 that leads to the merging point 104 detected by the merging point detection unit 62, and [3] the countermeasure control unit 66 adapted to (3a) perform a merging control that causes the host vehicle 100 to enter into the entry space 124 in the event that a search result is obtained from the entry space searching unit 64 which indicates that the entry space 124 exists, or on the other hand, to (3b) perform a countermeasure control to contend with merging into the merging destination lane 116 while continuing to automatically drive the host vehicle 100, in the event that a search result is obtained which indicates that an entry space 124 does not exist.

Further, in the vehicle control method in which the vehicle control device 10 is used to cause one or more CPU (or ECU) to implement the following steps: [1] a detection step (step S3) of detecting a merging point 104 during a congested state on a planned travel route of the host vehicle 100, [2] an entry space searching step (step S6) of searching for an entry space 124 for the host vehicle 100 within a merging destination lane 116 that passes through the merging point 104 while the host vehicle 100 is traveling by way of automated driving in a pre-merging lane 106 that leads to the detected merging point 104, and [3] a countermeasure step (steps S7 and S9) of performing a merging control (3a) that causes the host vehicle 100 to enter into the entry space 124 in the event that a search result is obtained which indicates that the entry space 124 exists, or on the other hand, to perform a countermeasure control (3b) to contend with merging into the merging destination lane 116 while continuing to automatically drive the host vehicle 100 in the event that a search result is obtained which indicates that an entry space 124 does not exist.

In this manner, in the case that a search result is obtained which indicates that an entry space 124 for the host vehicle 100 does not exist, a countermeasure control is performed to contend with merging into the merging destination lane 116 while automated driving of the host vehicle 100 is continued. Therefore, it is possible to continue with automated driving without interruption until a search result is obtained which indicates that an entry space 124 exists, and thus, driving convenience is improved in the case of traveling through a merging point 104 during a state of traffic congestion.

### [Supplemental Considerations]

The present invention is not limited to the embodiments described above, and it goes without saying that the present invention can be freely modified within a range that does not deviate from the essence and gist of the present invention. Alternatively, the respective configurations may be combined arbitrarily within a range in which no technical inconsistencies occur.

For example, in the present embodiment, although a description was given of a case in which the steering angle of the steering wheel is changed, the control target (steering angle) may be a different physical quantity or a controlled quantity related to steering of the host vehicle 100. For example, the steering angle may be a turning angle or a toe angle of the vehicle wheels 132F(R), or may be a steering angle command value defined inside the vehicle control device 10.

Further, in the present embodiment, although a configuration is adopted in which automatic steering of the steering wheel is performed, the means by which the steering angle is changed is not limited to this feature. For example, the vehicle control unit 60 may output a steer-by-wire command signal to the side of the steering device 30, and thereby change the steering angle as a turning angle of the vehicle wheels 132F(R). Alternatively, the steering angle as a turning angle of the vehicle wheels 132 F(R) may be changed by providing a torque difference (speed difference) between the inner wheels and the outer wheels.

Further, in the present embodiment, a case has been described in which the host vehicle 100 travels on an expressway 102. However, the present invention may be applied to other types of roads (for example, general roads) that include a pre-merging lane and a merging destination lane.

What is claimed is:

1. A vehicle control device adapted to at least partially carry out a travel control for a host vehicle by way of automated driving, comprising:
a merging point detection unit adapted to detect a merging point during a congested state on a planned travel route of a host vehicle;
an entry space searching unit adapted to search for an entry space for the host vehicle within a merging destination lane that passes through the merging point, while the host vehicle is traveling by way of automated driving in a pre-merging lane that leads to the merging point detected by the merging point detection unit; and
a countermeasure control unit adapted to perform a merging control that causes the host vehicle to enter into the entry space in the event that a search result is obtained from the entry space searching unit which indicates that the entry space exists, or on the other hand, to perform a countermeasure control to contend with merging into the merging destination lane while continuing to automatically drive the host vehicle, in the event that a search result is obtained which indicates that an entry space does not exist.

2. The vehicle control device according to claim 1, wherein, in the case that a search result is obtained which indicates that the entry space does not exist, the countermeasure control unit performs the countermeasure control to cause the host vehicle to stop in the pre-merging lane on a front side of the merging point.

3. The vehicle control device according to claim 2, wherein the countermeasure control unit performs the countermeasure control to cause the host vehicle to stop in a direction that facilitates merging of the host vehicle.

4. The vehicle control device according to claim 3, wherein the countermeasure control unit performs the countermeasure control to cause the host vehicle to stop in a state in which a vehicle body or a steering angle thereof is inclined in an orientation converging with the merging destination lane.

5. The vehicle control device according to claim 4, wherein, in the case that another vehicle in the pre-merging lane approaches from behind the host vehicle, the countermeasure control unit performs the countermeasure control to incline the steering angle in a direction away from the merging destination lane in a stopped state of the host vehicle.

6. The vehicle control device according to claim 2, further comprising a takeover request unit adapted to perform a request operation to request that a driver take over manual operation of the host vehicle, in the event that a search result is obtained which indicates that the entry space does not exist after a predetermined time period has elapsed from a point in time when the host vehicle was stopped.

7. The vehicle control device according to claim 1, wherein, in the case that a search result is obtained which indicates that the entry space does not exist, the countermeasure control unit performs the countermeasure control to operate a direction indicator on a side of the merging destination lane.
